(19) United States
(12) Patent Application Publication
(10) Pub. No.: US 2020/0201165 A1
(43) Pub. Date: Jun. 25, 2020

(54) PHOTOGRAPHY SYSTEM AND METHOD

(71) Applicant: AEON INTERNATIONAL LIMITED, Hong Kong (CN)

(72) Inventor: Simon P. Lock, Hong Kong (CN)

(73) Assignee: AEON INTERNATIONAL LIMITED, Hong Kong (CN)

(21) Appl. No.: 16/620,862

(22) PCT Filed: Jun. 7, 2018
(86) PCT No.: PCT/IB2018/054074

§ 371 Date: Dec. 9, 2019

Related U.S. Application Data
(60) Provisional application No. 62/517,597, filed on Jun. 9, 2017.

(51) Int. Cl. G03B 37/04; H04N 5/232; H04N 5/225; G03B 17/56

(52) U.S. Cl. CPC G03B 37/04; G03B 17/561; H04N 5/2258; H04N 5/23238

(57) ABSTRACT

The present invention relates to a photography system and method. The photography system includes a photography apparatus having a plurality of spaced apart image capture devices configured to capture an image of an object located within the photography apparatus at different angles. A controller in data communication with the image capture devices is configured to operate the image capture devices synchronously and to process the image of the object from each of the image capture devices to generate at least part of a simulated 360 degree impression image of the object.

### TECHNICAL FIELD

The present invention relates to a photography system and method. In particular, the photography system includes a photography apparatus having a plurality of spaced apart image capture devices configured to capture an image of an object located centrally within the photography apparatus at different angles of the object, and a controller configured to operate the image capture devices synchronously. Further, but not exclusively, the controller is configured to receive the image of the object from each of the image capture devices, and process the image of the object from each of the image capture devices so as to generate a 360 degree impression image of the object.

### BACKGROUND OF INVENTION

Existing photography methods for capturing images representing 360 degrees of an object typically involve locating the object to be photographed on a turntable and then capturing images of the object at different rotation angles of the turntable with an image capture device, such as a digital single Lens Reflex (SLR) camera. The turntable can either be manually operated or automatically operated in association with the digital camera.

In one existing photography method for capturing images representing 360 degrees of an object, the object is located centrally on an automatically operated turntable within a photography apparatus. The photography apparatus includes a lighting rig for illuminating the object, a suitable background for the image of the object, and an opening so that an image capture device, such as a compatible digital single Lens Reflex (SLR) camera, can capture images of the object as the image rotates on the turntable through the opening. In this method, the compatible digital camera and the turntable are controlled by an external controller, e.g. a computer, to synchronously capture images of the object at a designated frame rate for a full rotation of the turntable.

The images or frames of the object captured according to this existing method are then processed by the controller to generate an interactive 360 degree animation of the object. To do so, the images of the object taken at different angles of the object are processed by the controller to generate an interactive animation of the object in 360 degrees. The 360 degree animation is then outputted in a number of file options, such as an image file (e.g. JPG, TIFF, PNG, and RAW), a 360 degree animation file (e.g. HTML5, Flash and GIF), and a video file (e.g. MOV and MP4), for viewing.

In an example of this existing method in use, the object to be photographed is a human model or human-sized mannequin, and here the photography apparatus used must be sized to receive the human model or mannequin and to uniformly illuminate the human model or mannequin with the lighting rig. The lighting rig set up can thus be time consuming and costly. To capture suitable images of a human model at the different angles to generate the 360 degree animation of the human model, the human model is required to maintain the same pose (e.g. not even blink) whilst the turntable rotates a full rotation past the camera, and the lighting of the human model must be substantially the same for each of the images of each of the different angles for the stitching process to be successful. Furthermore, it is time consuming for the turntable to rotate a full 360 degrees while the digital camera captures all the required images of the different angles. Typically, 24 or 48 images are taken over the full rotation of the turntable to generate a quality 360 degree animation, and this rotation may take up to several minutes. Thus, to ensure that a quality 360 degree animation is generated, a professional operator of the digital camera is typically required to review the images before the processing of the images is performed.

Further, to capture suitable images of a human model or human-sized mannequin on the turntable in the photography apparatus at the different angles, the digital camera must located at a sufficient distance from the human model or human-sized mannequin for the perspective to be aesthetically pleasing, as well as to capture the entire human model or mannequin.

Before turning to a summary of the present invention, it will be appreciated that the above description of the exemplary prior art has been provided merely as background to explain the context of the invention. It is not to be taken as an admission that any of the material referred to was published or known, or was a part of the common general knowledge in the relevant art.

### SUMMARY OF INVENTION

According to one aspect of the present invention, there is provided a photography apparatus having a plurality of spaced apart image capture devices mounted to the photography apparatus, the image capture devices are configured to capture an image of an object located centrally within the photography apparatus at different angles of the object; and a controller in data communication with each of the image capture devices, wherein the controller is configured to operate the image capture devices synchronously, to receive the image of the object from each of the image capture devices, and to process the image of the object from each of the image capture devices to generate at least part of a simulated 360 degree impression image of the object.

According to another aspect of the present invention, there is provided a photography method including: locating an object centrally within a photography apparatus having a plurality of spaced apart image capture devices mounted to the photography apparatus; a controller operating the image capture devices synchronously to capture an image of the object located centrally within the photography apparatus at different angles of the object; receiving the image of the object from each of the image capture devices at the controller; and the controller processing the image of the object from each of the image capture devices to generate at least part of a simulated 360 degree impression image of the object.

Preferably, a “simulated 360 degree impression image” is an interactive image, where a viewer can interact with a 360 degree impression of an object (e.g. rotate) in the interactive image to generate views of the object that cover a full 360 degree horizontal rotation of the object. In addition, the object can also be rotated at least partially vertically to cover at least some vertical rotation of the object.

In one example, the object is a human model, human-sized mannequin or some other human-sized object. Each of the image capture devices mounted to the photography apparatus synchronously capture an image of, say, a human model located in the photography apparatus with, for example, near identical exposures. Preferably, the photography apparatus includes between 2 and 120 image capture devices mounted to the apparatus.

In one embodiment, the image capture devices are spaced apart around the circumference of the photography apparatus and the controller is configured to process the image of the object from each of the image capture devices to generate the simulated 360 degree impression image of the object. Here, the human model is not required to be rotated past a digital camera and to maintain the same pose for an extended period of time.

In another embodiment, the photography apparatus further includes a platform arranged to locate the object centrally thereon and to rotate the object relative to the image capture devices, wherein the controller is further configured to rotate the platform and operate the image capture devices synchronously. The controller is then configured to process the image of the object from each of the image capture devices following rotation of the platform to generate the simulated 360 degree impression image of the object.

In another embodiment, the photography apparatus further includes a rail having the image capture devices mounted thereto and the rail is configured to rotate the image capture devices about the object, wherein the controller is further configured to rotate the rail and operate the image capture devices synchronously. The controller is then configured to process the image of the object from each of the image capture devices following rotation of the rail to generate the simulated 360 degree impression image of the object.

Accordingly, in each the embodiments, an operator of the photography system is not required to review the images before processing. It will be appreciated by those persons skilled in the art, however, that any sized object can be photographed using the above photography system and method to generate a simulated 360 degree impression image of that object, and the synchronous capture of the images of the object in the photography apparatus with identical or near exposures provides an consistent 360 degree impression image of the object.

It will also be appreciated by those persons skilled in the art that the controller, in data communication with the image capture devices, can be co-located with the image capture devices and the photography and the photography apparatus or in data communication with the image capture devices over a network. Further, one controller can be configured to control more than one photography apparatus over a network. In any event, the controller typically includes a processor and a memory, with program code stored on the memory to implement the functions of the controller such as processing the image of the object.

As mentioned, in one embodiment, the image capture devices are spaced apart around a circumference of the photography apparatus and the object is located centrally within the photography apparatus. With respect to the human-sized object example, the photography apparatus is cylindrical in shape, with a diameter of the circumference of the photography apparatus being two metres and the longitudinally height also being 2.2 metres so as to fit a human-sized object to be located therein. Other shapes and dimensions of the photography apparatus are also envisaged to fit different sized objects, such as the photography apparatus being cuboid in shape.

In an embodiment, the controller is further configured to process the image of the object from each of the image capture devices using a neural network algorithm to generate the simulated 360 degree impression image of the object, whereby the neural network algorithm was trained on images of a further object located centrally within the photography apparatus that was captured at different angles. Here, the images of the further object for the neural network algorithm were captured at designated different angles spaced around 360 degrees of the further object. For example, the images of the further object for the neural network algorithm were captured at 24 different angles.

In addition, the neural network algorithm may include a first neural network that was trained on said images of the further object that were captured at designated different angles and a second neural network that was trained on images of further objects that were captured at random different angles. These further objects may have different heights and shapes and the second neural network was trained on said images of said further objects that were captured at random different lighting conditions and random different ranges.

In an embodiment, the controller stitches the image of the object (e.g. substantially horizontally and vertically) to generate the simulated 360 degree impression image of the object. As mentioned, the controller is a computer, which includes a processor in data communication with a memory to implement program code, to perform the stitching by combining the multiple images of the object taken by each of the image capture devices. As mentioned, in one embodiment, all images of the object are taken synchronously with the same lighting conditions so that they have substantially identical exposures for seamless stitching of the images to generate the 360 degree impression image. In another embodiment, the images of the object are taken synchronously and sequentially with designated lighting conditions so that they have desired identical exposures for stitching of the images to generate the 360 degree impression image.

In one embodiment, the image capture devices are equally spaced apart around the circumference of photography apparatus so that the multiple images of the object taken by each of the image capture devices are equal sized image segments of the object that are to be combined by stitching. The distance between the image capture devices on the circumference of the photography apparatus and the size of the circumference is thus designated based on the size of the object being photographed and the image capture devices. Preferably, the image capture devices are equally spaced apart around the circumference of photography apparatus in rows. For example, there are five rows of image capture devices mounted around the circumference of the photography apparatus. The controller then processes the image of the object from each of the image capture devices, in the manner described above, by stitching the image of the object substantially vertically and horizontally to generate the 360 degree impression image of the object.

In another embodiment, the photography apparatus includes two or more of the image capture devices spaced apart longitudinally on the photography apparatus to capture an image of the object at different angles of the object. Here, the object is rotated past the longitudinal array of image capture devices.

It will be appreciated by those persons skilled in the art that each image capture device has a Field of View (FOV) determined by the optics and the image sensor of the image capture devices. The image capture devices may have identical components, and an identical FOV. Thus, in one embodiment, to generate a 360 degree impression image of an object such as a human model, a sufficient number of image capture devices are mounted at equal intervals around a sufficiently large circumference of the photography apparatus for all of the model to be in the FOV and for sufficient image segments of the model to be captured for stitching to generate the simulated 360 degree impression image. For example, the diameter of the photography apparatus is 2.5 metres and there are twenty four image capture devices mounted at even intervals around the circumference of the photography apparatus.

The image capture devices may have a sensor size, aperture, and/or focal length combination to capture a large depth of field encompassing the whole of the object (e.g. human model) with a high degree of sharpness. The image capture devices may also have a sensor size, aperture, and/or focal length combination to capture images rich in chromatic aberration, effectively encoding depth information in the colour fringes. For example, with reference to the embodiment where the neural network algorithm is used to generate the simulated 360 degree impression image of the object, multiple images at different depths are used to train the neural network algorithm.

In the example of a typical human-sized model, it will be appreciated that the distance between the image capture devices on the longitudinal axis of the photography apparatus is also designated based on the size of a typical human model and the FOV of the image capture devices. As each camera is only required to capture an image of part of the human model, the circumference of the photography apparatus can be reduced. For example, if only one quarter of the model is required in the FOV of each image capture device when four image capture device are mounted longitudinally, the diameter of the photography apparatus can be reduced to around 2 metres. Specifically, in this example, the diameter of the photography apparatus is 2 metres and there may be twenty four image capture devices mounted at even intervals around the circumference of the photography apparatus in four evenly spaced apart rows of image capture devices.

In an embodiment, the controller processes the image of the object from each of the image capture devices by compensating for distortion in the image of the object and aligning the image of the object substantially vertically and horizontally before stitching the image of the object to generate the simulated 360 degree impression image of the object. Alternatively, the controller processes the image of the object from each of the image capture devices by stitching the image of the object geometrically and then compensates for distortion in the image of the object using an optical flow algorithm to generate the simulated 360 degree impression image of the object.

For example, each image capture device on the vertical axis instantly captures images of different perspectives of the entire height of the same object. After capture, the controller runs the below algorithms over the images to create one vertically stitched image:
a) find edge and etch outline of subject model;
b) re-scale each image to adjust scale depending on varying focal lengths;
c) correct distortion or warping; and
d) blend or stitch all images to create one output file

In an embodiment, the photography apparatus includes a plurality of poles (e.g. extending longitudinally) on the photography apparatus and spaced around the circumference of the photography apparatus, wherein the image capture devices are mounted to the poles.

In one embodiment, the photography apparatus includes five rows of image capture devices mounted on twenty four of said poles. That is, there are 120 image capture devices capturing 120 different images of the object at 15 degree segments. In another embodiment, the photography apparatus includes three rows of two image capture devices mounted on poles in an arcuate portion of the photography apparatus. That is, there are 6 image capture devices capturing different images of the object and, over a full rotation of the object (or the image capture devices), the controller processes the multiple images of the object from each of the 6 image capture devices to generate the simulated 360 degree impression image of the object.

Preferably, the poles can be assembled, with suitable fixing means, to form the photography apparatus and disassembled with ease by an operator of the photography apparatus. In this way, the photography apparatus can be easily transportable and used anywhere.

In an embodiment, the photography apparatus includes one or more light sources mounted to the photography apparatus configured to operate to illuminate the object located within the photography apparatus. In the embodiment, the controller is then configured to operate the image capture devices, the platform and the light sources synchronously such that the object is illuminated at designated lighting levels as the object is rotated on the platform relative to the image capture devices.

### BRIEF DESCRIPTION OF DRAWINGS

Embodiments of the present invention will now be described, by way of example only, with reference to the accompanying drawings, in which:

FIG. 1 is a representation of a photography system according to an embodiment of the present invention;

FIG. 2 is another representation of a photography system according to the embodiment of FIG. 1;

FIG. 3 is a representation of a portion of a wall of a photography apparatus according to an embodiment of the present invention;

FIG. 4 is a cross-sectional representation of the portion of FIG. 3;

FIG. 5 is a representation of an object located within a photography apparatus according to an embodiment of the present invention;

FIG. 6 is a representation of a 360 degree impression image of the object of FIG. 5 generated according to an embodiment of the present invention;

FIG. 7 is a representation of a photography system according to an embodiment of the present invention;

FIG. 8 is a representation of image capture devices mounted on a pole of a photography apparatus configured to capture an image of an object according to an embodiment of the present invention;

FIG. 9 is a representation of images of the object captured according to the embodiment of FIG. 8;

FIG. 10 is a representation of an image of the object shown in FIG. 9 generated according to an embodiment of the present invention;

FIG. 11 is a representation of a display of an interface showing partial images of an object generated according to an embodiment of the present invention;

FIG. 12 is a flow chart representative of a photography method according to an embodiment of the present invention;

FIG. 13 is a representation of a photography system according to an embodiment of the present invention;

FIG. 14 is a representation of a photography system according to another embodiment of the present invention; and

FIG. 15 is a representation of a photography system according to another embodiment of the present invention.

### DETAILED DESCRIPTION

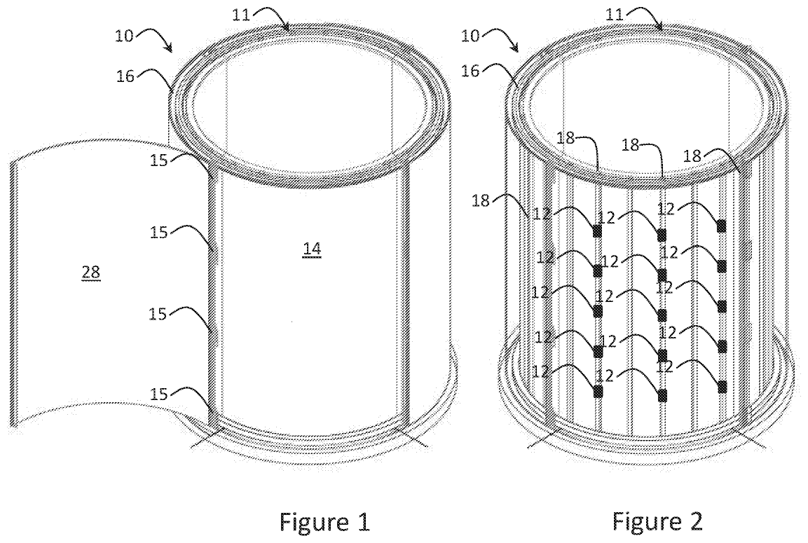

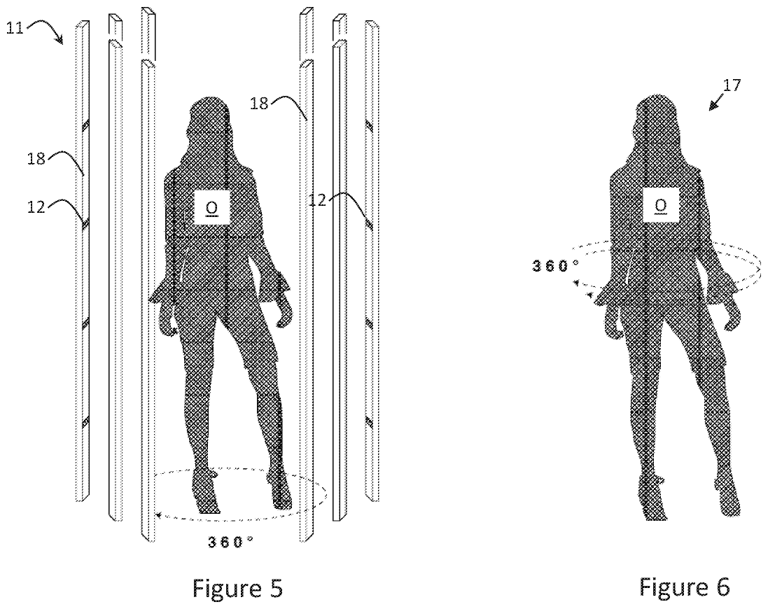

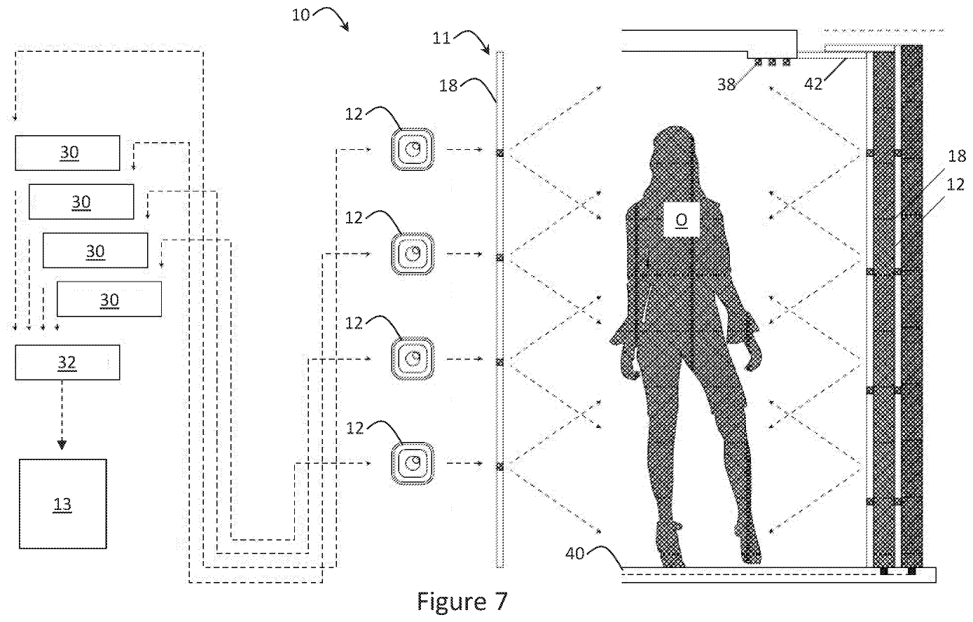

An embodiment of a photography system 10 including a photography apparatus 11 having a plurality of spaced apart image capture devices 12 mounted to the photography apparatus 11 is shown in FIGS. 1 and 2. The image capture devices 12 are shown in FIG. 2 and are configured to capture an image of an object at different angles, shown in FIGS. 5 to 10 as human model O, located centrally within the photography apparatus 11. The photography system 10 also includes a controller 13 (shown in FIG. 7) in data communication with each of the image capture devices 12. As described, the controller 13 can be collocated with the photography apparatus 11 or remote from the photography apparatus 11, in data communication with the image capture devices 12 over a data network, such as a wireless LAN or the Internet.

The controller 13 is configured to operate the image capture devices 12 synchronously, to receive the image of the object from each of the image capture devices 12. That is, controller 13 signals to each of the image capture devices 12 at substantially the same time to capture an image of the object. In this way, the lighting conditions are consistent for each image of the object. Also, the controller 13 processes the images of the object taken from each of the image capture devices 12 to generate a simulated 360 degree impression image—shown as a 360 degree impression image 17 of model O in FIG. 6—of the object. The simulated 360 degree impression image is outputted by the controller 13 in the desired file type, such as an image file (e.g. JPG), a 360 degree animation file (e.g. HTML5), and a video file (e.g. MP4), for use, such as for viewing on a computer. As described, the controller 13 in the embodiment is also computer, with a processor and a memory having program code stored thereon to implement the steps required to generate the 360 degree impression image of the object.

As mentioned, in the embodiments, the object is a human model or human-sized mannequin. Accordingly, the photography apparatus 11 is sized to capture images of the human-sized model. In the embodiments, the photography apparatus 11 is cylindrical in shape. And, in one embodiment, the photography apparatus 11 has a diameter of 2 metres and a longitudinally height of 2.2 metres so as to fit a human-sized object therein. The object, in the form of say a human, has access to the photography apparatus 11 via an opening 14 in the cylindrical photography apparatus 11. The opening 14 in FIG. 1 is provided by a door 28 configured to pivot open on hinges 15 to allow access for the object to the photography apparatus 11, and to pivot closed after the images of the object are captured.

The image capture devices 12 are equally spaced apart around a circumference 16 of the photography apparatus 11 and the object is located centrally within the photography apparatus 11 to be imaged. The image capture devices 12 are shown in FIG. 2 as being mounted to only three poles 18 for illustrative purposes. As can be seen in FIG. 2, the photography apparatus 11 includes a plurality of these poles 18 extending longitudinally along the circumference 16 of the photography apparatus 11 and they are evenly spaced around the circumference 16. As mentioned, the image capture devices 12 are mounted to each of the poles 18 so as to capture images of all sides of the object simultaneously.

In the embodiment, the image capture devices 12 are spaced apart 12 longitudinally as well as circumferentially on each of the poles 18 of the photography apparatus 11 so that the photography apparatus 11 has a plurality of rows of spaced apart image capture devices 12 around the circumference 16 of the photography apparatus 11. FIGS. 1 to 5 show five rows of image capture devices 12 mounted to the poles 18. In this embodiment, there are five rows of image capture devices 12 mounted on twenty four of the poles 18. Thus, here there are 120 image capture devices 12. It will be appreciated, however, that other numbers and arrangements of image capture devices may be employed by the photography system 10, depending on the Field of View (FOV) of each of the image capture devices 12 and the size of the object being imaged.

The image capture devices 12 in the embodiment have a number of components to capture the images, including, but not limited to, a lens, an image sensor, a processor and a memory. The processor implements program code stored on the memory to receive instructions from the controller 13 to capture an image, and then to receive and process information from the image sensor of the object, as well as to output the image. The lens and the image sensor are sized to provide a desired Field of View (FOV) that is applied to the object.

The controller 13 of the photography system 10 receives the images from each of the image capture devices 12 and processes these images of the object by stitching these images of different segments of the object together to generate the simulated 360 degree impression image of the object, in the manner described above. Alternatively, the controller 13 processes the image of the object from each of the image capture devices 12 using a neural network algorithm to generate the simulated 360 degree impression image of the object and the neural network algorithm was trained on images of a further object located centrally within the photography apparatus 11 that was captured at different angles.

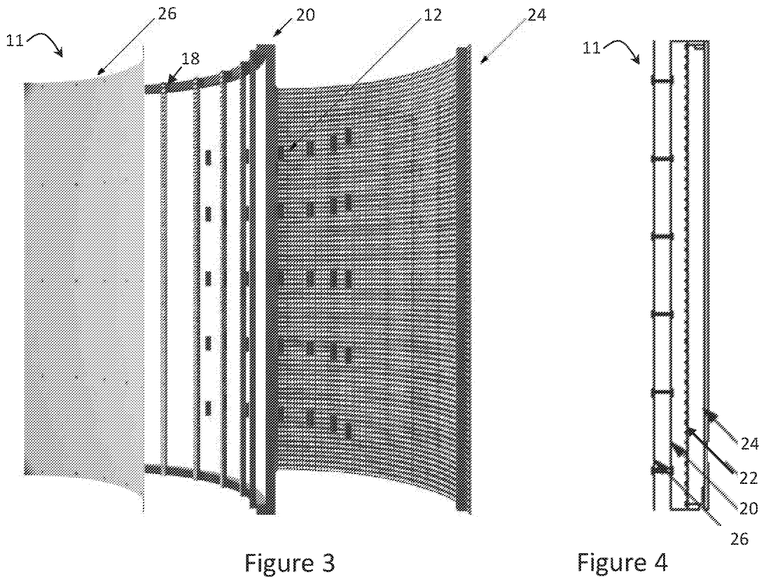

FIGS. 3 and 4 show a portion of a wall of the photography apparatus 11 and an exploded view of that portion of the wall, respectively. The photography apparatus 11 includes a frame 20 configured to receive the poles 18 in a spaced apart manner. As described, by mounting the image capture devices 12 on the poles 18, the poles 18 can be readily assembled and dissembled to the photography apparatus 11 with suitable fixing means, making the photography apparatus 11 fairly portable. Shown in FIG. 7, the photography apparatus 11 has a circular base or platform 40 and a circular ceiling 42, and these components are configured to mate with the frame 20 to form the structure of the cylindrical photography apparatus 11. The image capture devices 12 are thus mounted in the desired spaced apart locations longitudinally and circumferentially with respect to the photography apparatus 11 when the poles are assembled to form the cylindrical photography apparatus 11.

The photography apparatus 11 further includes a cylindrical outer wall 24, and a cylindrical inner wall 26 on either side of the frame 20. As described, the opening 14 is a retractable door 28 in the inner 26 and outer 24 walls so that the object can access the interior of the photography apparatus 11 to be imaged. The interior wall 26 is a translucent layer in the form of a frosted or milky acrylic layer to diffusely transmit and diffusely reflect light in the photography apparatus 11. Although, not shown in the Figures, at least part of the image capture devices 12 are mounted to the translucent layer 26 such as via an aperture in the translucent layer 26 so that the translucent layer 26 does not interfere with the capturing of the images.

The photography apparatus 11 also includes a plurality of light sources 22 mounted to the frame 16 and or to the outer wall 24, such as LED light sources, which are configured to operate to illuminate the object located within the photography apparatus 11. In one embodiment, the controller 13 operates the LED light sources 22 to ensure that the object is illuminated uniformly so that the images of the object have a consistent light exposure for improved stitching of the images to generate a quality 360 degree impression image of the object.

The ceiling 42 and the base 38 of the photography apparatus 11 are mounted to the inner 26 and outer wall 24, as well as the frame 20, to form the photography apparatus 11. The ceiling 42 also includes an overhead light source 38 mounted thereto, as shown FIG. 7, which is also an LED light source. In the embodiment, the overhead light source 38 is also controlled by the controller 13 to ensure that the object is illuminated uniformly.

Operation of the photography system 10 will now be described with reference to FIGS. 5 to 10. In the embodiment shown in these Figures, the object is a human model O that is located within the photography apparatus 11 to be photographed. For example, the human model is modelling clothing and the simulated 360 degree impression image shows the model wearing the clothing in 360 degrees.

As mentioned, the photography apparatus 11 is dimensioned to capture images of a human-sized model to generate a simulated 360 degree impression image 17 shown in FIG. 6 of the model O. As mentioned, the dimensions of the photography apparatus 11 are selected based on the FOV of the image capture devices 12 and the number of image capture devices 12 required to generate the 360 degree impression image 17 of the model O. In the embodiment show in FIG. 5, there are 120 image capture devices 12, mounted on 24 poles 18, capturing 120 different images of the model O at 15 degree segments. In the embodiment shown in FIGS. 7 to 10, however, there are 96 image capture devices 12, mounted on 24 poles 18, capturing 96 different images of the model O at 15 degree segments. In respect of this embodiment, if the FOV of the image capture devices 12 is the same as the embodiment where five image capture devices are mounted to one pole, the circumference of the photography apparatus 11 will be larger to ensure that the whole of the model O is still captured in the images. For example, the photography apparatus 11 shown in FIGS. 7 to 10 has a diameter of 2.2 metres and a longitudinally height of 2.2 metres to fit the model O therein and to image the entirety of the model O.

Further, in the embodiment shown in FIGS. 7 to 10, the controller 13 operates the image capture devices 12 to synchronously capture images of the model 0, when the model O is located within the photography apparatus 11. The model O is located centrally within the photography apparatus 11 and illuminated uniformly with the wall mounted light sources 22 and or ceiling mounted light source 38, as described.

In one embodiment, the controller 13 receives the different images from the image capture devices 12 and processes the images by stitching the images substantially vertically and horizontally to generate the 360 degree impression image 17 of the model O. The controller 13 also processes the images from each of the image capture devices 12 by compensating for distortion in the images and aligning the images substantially vertically and horizontally before stitching the images substantially vertically and horizontally to generate the 360 degree impression image 17 of the model O.

In another embodiment, as mentioned, the controller 13 receives the images from the image capture devices 12 and processes the images using a neural network algorithm to generate the simulated 360 degree impression image of the object. For example, there are 24 poles 18 spaced circumferentially each having 4 image capture devices 12 spaced longitudinally on the apparatus 11 so as to capture images at different angles of the object. This neural network algorithm was previously trained on images of other objects located within the photography apparatus that were captured at these different designated angles.

Further, the neural network algorithm may include two neural networks. The first neural network has been trained on an existing dataset of 360 degree impression images to map a latent vector or a feature descriptor into a set of 24 images to form a 360 degree impression image with the required angles and perfect lighting. The second neural network is trained to produce an identical latent vector or feature descriptor from images captured from a variety of different angles and lighting scenarios. Great diversity of lighting and angles is captured, and subsets of images are used to train the second neural network to robustly produce perfect 360 degree impression images in perfect lighting from a minimal set of imperfect captures in imperfect lighting at undefined angles. In this way, the controller 13 uses the two neural networks to generate the simulated 360 degree impression image of the object from the different angles.

In yet another embodiment, some of the image processing is performed locally with respect to the photography apparatus 11. In the embodiment shown in FIGS. 7 to 10, the photography apparatus 11 includes image processors 30 for each of the image capture devices 12, configured to generate images four images 34A 34B 34C 34D of the model O, respectively. The image processors are configured to communicate with a pole based image processor 32, for example mounted to each pole 18, for vertically stitching images taken by the image capture devices 12 mounted to each particular pole 18.

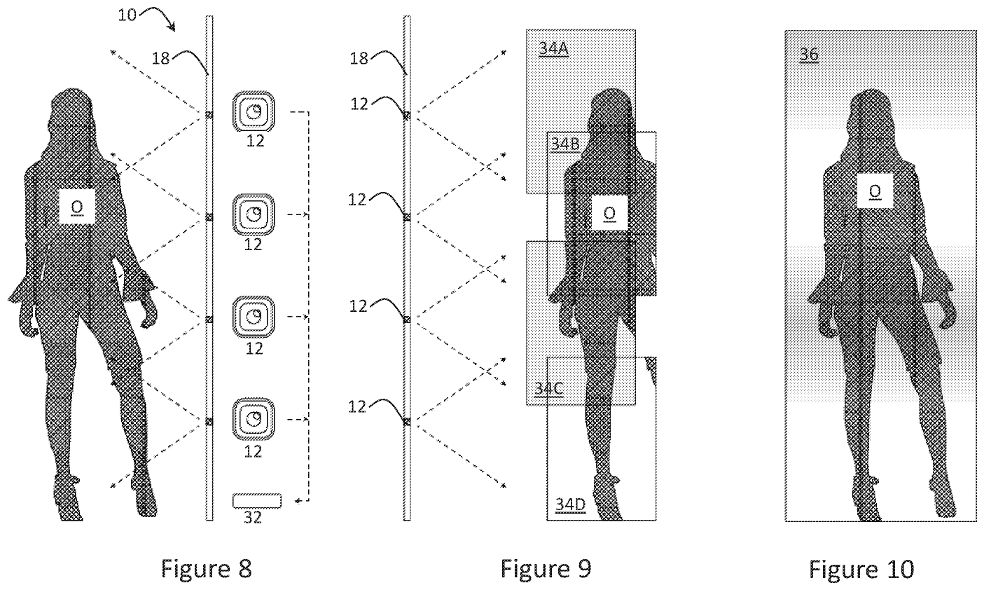

FIGS. 8 to 10 show the model O located with the photography apparatus 11, and image capture devices 12 mounted to one particular pole 18 configured to capture images of the model O, synchronously. The four image capture devices 12 mounted to one pole 18 capture four images 34A 34B 34C 34D of a substantially different vertical part of the model O with some overlap. The pole based image processor 32 is configured to process these four images 34A 34B 34C 34D of the model O and stitch these images of the object substantially vertically to generate a partial 360 degree impression image 36 of the model O. The partial 360 degree impression images 36 of the model O, received each of the different pole based image processors 32, are then sent to the controller 13, via a data network, for processing and stitching substantially horizontally to generate the 360 degree impression image 17 of the model O.

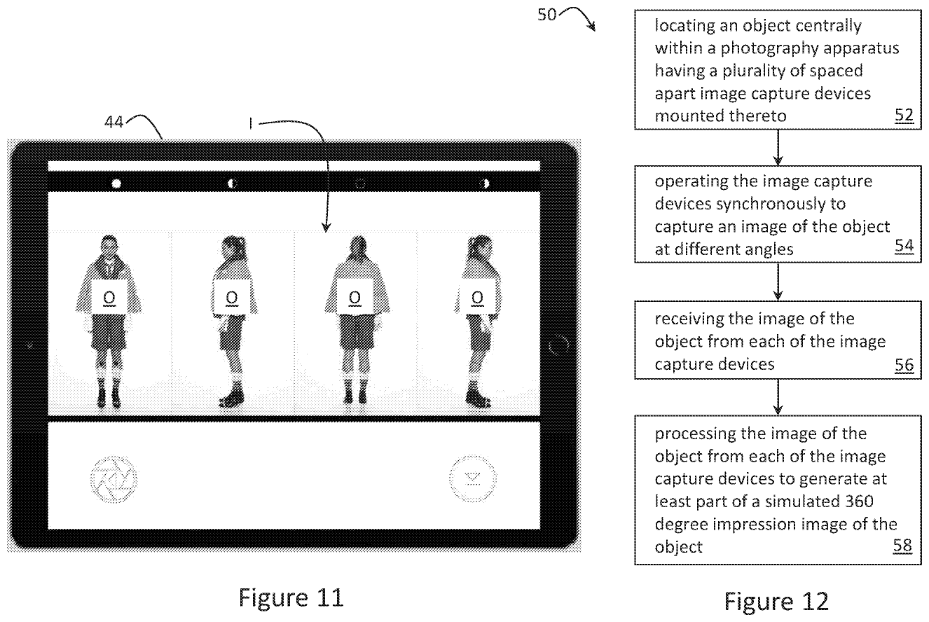

In an embodiment, an Interface I is presented to an operator of the photography apparatus 11 on a display 44 for reviewing and potentially altering images captured of the model O using the photography apparatus 11, as shown in FIG. 11. To do so, partial 360 degree impression images 36 of the model O are captured and sent to the controller 13, via a data network, as above, for processing and stitching substantially horizontally and vertically to generate four partial images of the model O. These four partial images of the 360 degree impression image 17 of the model O are a front, left, right and back side image of the model O. The operator of Interface I can then view these partial images and determine whether one or more of these partial images should be retaken to generate the final 360 degree impression image 17 of the model O.

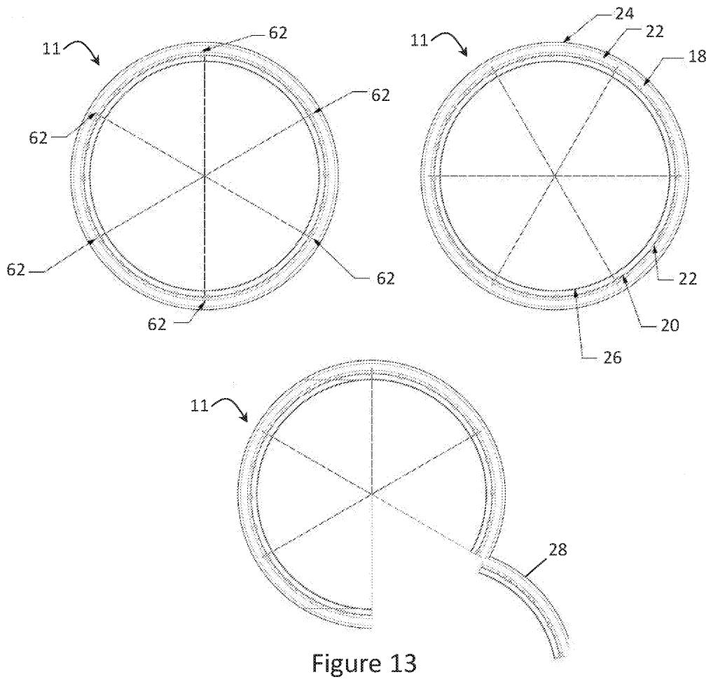

FIG. 13 shows an embodiment of the photography apparatus 11 being assembled from six equal dimensioned portions. It will be appreciated by those persons skilled in the art that other configurations are possible, such as the photography apparatus 11 being assembled from four portions. In any event, these portions enable the photography apparatus 11 to be portable and to be sized to fit through standard sized doorways of buildings in a semi-assembled form. Further, it can be seen that each of the portions have hinges 62 for assembly of the apparatus 11, and the cylindrical shaped apparatus 11 may be provided with an external case for durability. In the assembled position, it can be seen that the photography apparatus 11 has a plurality of poles 18 spaced apart around the circumference of the frame 20 of the photography apparatus 11. Further, the apparatus 11 has an opening as discussed above provided by one of the portions.

Turning now to FIG. 12, there is shown a flow chart 50 of a photography method including the steps of: locating 52 an object centrally within a photography apparatus having a plurality of spaced apart image capture devices mounted to the photography apparatus; a controller operating 54 the image capture devices synchronously to capture an image of the object located centrally within the photography apparatus at different angles of the object; receiving 56 the image of the object from each of the image capture devices at the controller; and the controller processing 58 the image of the object from each of the image capture devices to generate at least part of a simulated 360 degree impression image of the object.

Further aspects of the method will be apparent from the above description of the photography system 10. Persons skilled in the art will appreciate that the method 50 could be embodied in program code, for implementation by a processor of the controller 13, which could be supplied in a number of ways; for example on a computer readable medium, such as a disc or a memory of the controller 13, or as a data signal, such as by transmission from a server.

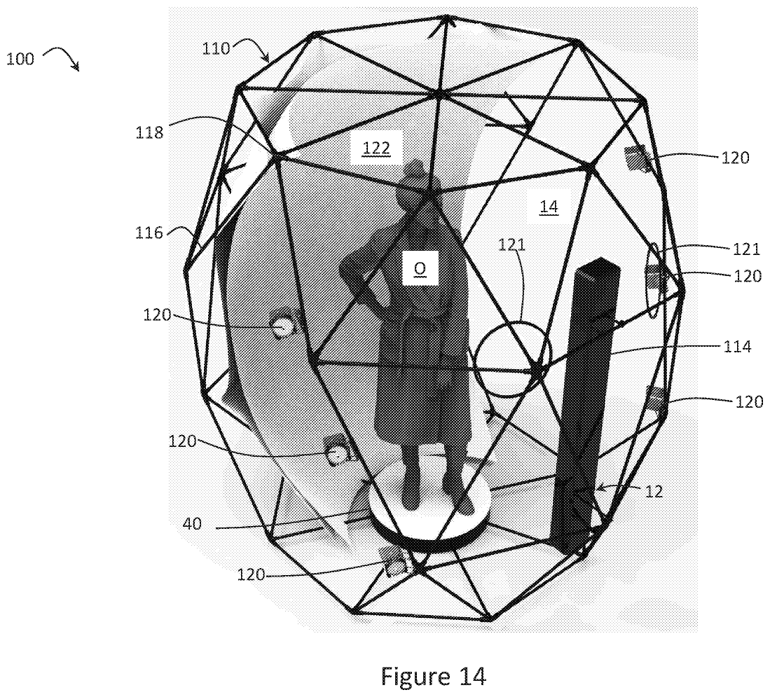

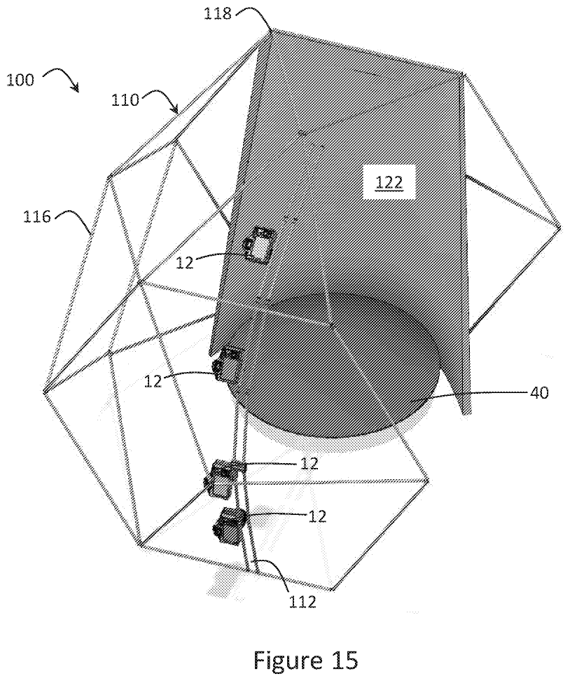

Two different embodiments of a photography system 100 are shown in FIGS. 14 and 15, respectively. The photography system 100 of both embodiments includes a photography apparatus 110 having a plurality of spaced apart image capture devices 12 mounted to the photography apparatus 110. Four image capture devices 12 are shown in FIG. 15 as being spaced apart longitudinally on the photography apparatus 110, and mounted to a rail 112 of the photography apparatus 110. The image capture devices 12 in FIG. 14 are also spaced apart longitudinally (not shown) within housing 114 on the photography apparatus 110. As above, it will also be appreciated that other numbers and arrangements of image capture devices may be employed by the photography system 100, depending on the Field of View (FOV) of each of the image capture devices 12 and the size of the object being imaged.

The image capture devices 12 of the two embodiments of the photography system 100 are also configured to capture an image of an object at different angles, shown in FIGS. 5 to 10 as human model O, located centrally within the photography apparatus 11. Also as above, the photography system 100 also includes a controller 13 in data communication with each of the image capture devices 12. As described, the controller 13 can be collocated with the photography apparatus 11 or remote from the photography apparatus 11, in data communication with the image capture devices 12 over a data network, such as a wireless LAN or the Internet.

The controller 13 in the embodiments of FIGS. 14 and 15 is configured to operate the image capture devices 12 synchronously, and to receive the image of the object from each of the image capture devices 12. That is, controller 13 signals to each of the image capture devices 12 at substantially the same time to capture an image of the object. In this way, the lighting conditions are consistent for each image of the object for one arcuate view of the object. The controller 13 processes these images of the object taken from each of the image capture devices 12 to generate part of a simulated 360 degree impression image. To generate the simulated 360 degree impression image, the controller 13 is further configured to rotate platform 40 and to operate the image capture devices 12 synchronously. The controller 13 processes the images of the object from each of the image capture devices 12 following a full, substantially full rotation of the object, to generate the simulated 360 degree impression image of the object. The simulated 360 degree impression image is again outputted by the controller 13 in the desired file type, such as an image file (e.g. JPG), a 360 degree animation file (e.g. HTML5), and a video file (e.g. MP4), for use, such as for viewing on a computer.

As above, in the embodiments of FIGS. 14 and 15, the object is a human model O or human-sized mannequin. Accordingly, the photography apparatus 110 is sized to capture images of the human-sized model O. In the embodiments, the photography apparatus 110 is a polyhedron. Specifically, the photography apparatus 110 is substantially a geodesic polyhedron with a diameter of 2 metres and a longitudinally height of 2.2 metres so as to fit a human-sized object O therein. The human-sized object O has access to the photography apparatus 110 via an opening 14, shown more clearly in FIG. 14, in the photography apparatus 110. The controller 13 of the photography system 10 receives the images from each of the image capture devices 12 and processes these images of the object by stitching these images of different segments of the object together to generate the simulated 360 degree impression image of the object, in the manner described above. In addition to the controller 13 stitching the images of the object geometrically, the controller 13 compensates for distortion in the image of the object using an optical flow algorithm to generate the simulated 360 degree impression image of the object.

The polyhedron shaped photography apparatus 110 is a frame constructed from poles 116 and fittings 118 for the poles 116. In this way, the frame of the photography apparatus 110 can be readily assembled and dissembled making the photography apparatus 11 fairly portable.

The photography apparatus 110 further includes a curved background 122, mounted to the frame of the photography apparatus 110 to diffusely reflect light in the photography apparatus 110. In use therefore, the human model O enters the photography apparatus 110 via that opening 14 and stands substantially centrally on the platform 40 to be imaged. The curved background 122 diffusely reflects light in the photography apparatus 11 from a plurality of light sources 120 121 mounted to poles 116 of the photography apparatus 110. The light sources 120 121 mounted to the frame can be LED light sources, and are configured to be operably by the controller 13 to illuminate the object O located within the photography apparatus 11 with desired lighting conditions. In one embodiment, the controller 13 operates the light sources 120 121 to ensure that the object is illuminated uniformly so that the images of the object have a consistent light exposure for stitching of the images to generate a quality simulated 360 degree impression image of the object. In another embodiment, to enhance the simulated 360 degree impression image of the object, the light sources 120 121 may be controlled by the controller 13 to alter the illumination levels for different angles of the object. In this way, the controller 13 can be configured to provide lighting that enhances shadows in, for example, fabric ruffles and produce more defined edges in the clothing worn by the human model O.

It is to be understood that various alterations, additions and/or modifications may be made to the parts previously described without departing from the ambit of the present invention, and that, in the light of the above teachings, the present invention may be implemented in a variety of manners as would be understood by the skilled person.

1. A photography system, including:
a photography apparatus having a plurality of spaced apart image capture devices mounted to the photography apparatus, the image capture devices are configured to capture an image of an object located centrally within the photography apparatus at different angles of the object; and
a controller in data communication with each of the image capture devices, wherein
the controller is configured to operate the image capture devices synchronously, to receive the image of the object from each of the image capture devices, and to process the image of the object from each of the image capture devices to generate at least part of a simulated 360 degree impression image of the object.

2. A photography system of claim 1, wherein the image capture devices are spaced apart around a circumference of the photography apparatus and the controller is configured to process the image of the object from each of the image capture devices to generate the simulated 360 degree impression image of the object.

3. A photography system of claim 1, wherein the photography apparatus further includes a platform arranged to locate the object centrally thereon and to rotate the object relative to the image capture devices, wherein the controller is further configured to rotate the platform and operate the image capture devices synchronously.

4. A photography system of claim 3, wherein the controller is further configured to process the image of the object from each of the image capture devices following rotation of the platform to generate the simulated 360 degree impression image of the object.

5. A photography system of claim 1, wherein the photography apparatus further includes a rail having the image capture devices mounted thereto and the rail is configured to rotate the image capture devices about the object, wherein the controller is further configured to rotate the rail and operate the image capture devices synchronously.

6. A photography system of claim 5, wherein the controller is further configured to process the image of the object from each of the image capture devices following rotation of the rail to generate the simulated 360 degree impression image of the object.

7. A photography system as claimed in claim 2, wherein the controller is further configured to process the image of the object from each of the image capture devices using a neural network algorithm to generate the simulated 360 degree impression image of the object, whereby the neural network algorithm was trained on images of a further object located centrally within the photography apparatus that was captured at different angles.

8. A photography system as claimed in claim 7, wherein the images of the further object for the neural network algorithm were captured at designated different angles spaced around 360 degrees of the further object.

9. A photography system as claimed in claim 8, wherein the neural network algorithm includes a first neural network that was trained on said images of the further object that were captured at designated different angles and a second neural network that was trained on images of further objects that were captured at random different angles.

10. A photography system as claimed in claim 9, wherein the further objects have different heights and shapes and the second neural network was trained on said images of said further objects that were captured at random different lighting conditions and random different ranges.

11. A photography system as claimed in claim 2, wherein the controller stitches the image of the object from each of the image capture devices to generate the simulated 360 degree impression image of the object.

12. A photography system as claimed in claim 11, wherein the controller processes the image of the object from each of the image capture devices by compensating for distortion in the image of the object and aligning the image of the object substantially vertically and horizontally before stitching the image of the object substantially vertically and horizontally to generate the simulated 360 degree impression image of the object.

13. A photography system as claimed in claim 11, wherein the controller stitches the image of the object from each of the image capture devices geometrically and then compensates for distortion in the image of the object using an optical flow algorithm to generate the simulated 360 degree impression image of the object.

14. A photography system as claimed in claim 2, wherein the photography apparatus has a plurality of rows of said image capture devices extending longitudinally and spaced apart around the circumference of the photography apparatus.

15. A photography system as claimed in claim 14, wherein the photography apparatus includes a plurality of poles extending longitudinally on the photography apparatus and spaced around the circumference of the photography apparatus, wherein the image capture devices are mounted to the poles.

16. A photography system as claimed in claim 1, wherein the photography apparatus includes 2 to 120 of said image capture devices.

17. A photography system of claim 1, wherein the photography apparatus includes two or more of the image capture devices spaced apart longitudinally on the photography apparatus.

18. A photography system as claimed in claim 1, wherein the photography apparatus includes one or more light sources mounted to the photography apparatus, the one or more light sources are configured to be operated by the controller to illuminate the object located within the photography apparatus.

19. A photography system as claimed in claim 18, wherein the photography apparatus further includes a platform arranged to locate the object centrally thereon and to rotate the object relative to the image capture devices, wherein the controller is further configured to rotate the platform and operate the image capture devices synchronously, wherein the controller is further configured to process the image of the object from each of the image capture devices following rotation of the platform to generate the simulated 360 degree impression image of the object, and wherein the controller is configured to operate the image capture devices, the platform and the light sources synchronously such that the object is illuminated at designated lighting levels as the object is rotated on the platform relative to the image capture devices.

20. A photography method including:
locating an object centrally within a photography apparatus having a plurality of spaced apart image capture devices mounted to the photography apparatus;
a controller operating the image capture devices synchronously to capture an image of the object located centrally within the photography apparatus at different angles of the object;
receiving the image of the object from each of the image capture devices at the controller; and
the controller processing the image of the object from each of the image capture devices to generate at least part of a simulated 360 degree impression image of the object.
